(19) United States
(12) Patent Application Publication
(10) Pub. No.: US 2008/0137362 A1
(43) Pub. Date: Jun. 12, 2008

(54) Lighting Device Having at Least Two Optical Systems

(76) Inventor: John Gjettermann, Stenstrup (DK)

Correspondence Address: NATH & ASSOCIATES, 112 South West Street, Alexandria, VA, 22314, US

(21) Appl. No.: 11/666,755

(22) PCT Filed: Nov. 2, 2005
(86) PCT No.: PCT/DK05/00699

§ 371 Date: Jun. 18, 2007

(30) Foreign Application Priority Data
Nov. 2, 2004 (DK) PA 2004 01682

(51) Int. Cl. F21S 4/00; F21V 7/04; F21V 29/00

(52) U.S. Cl. 362/572; 362/554; 362/294; 362/310

(57) ABSTRACT

A lighting device is provided, which comprises at least two optical systems, each being aligned along a separate optical axis and a light source arranged along said optical axes. Each of the optical systems comprise a reflector arranged on a first side of the light source along the optical axis, said reflector being adapted to reflect substantially all incoming light and having a curvature radius substantially equal to the distance to the light source, a condensing device arranged on a second opposite side of the lamp along the optical axis, said condensing device being adapted to receive directly incoming light from the light source and reflected light from the reflector and focusing said directly incoming and said reflected light, a light guide having a first end and a second end, said first end being arranged along the optical axis and adapted to collect and transmit substantially all of the light passing through the condensing device, said second end emitting said collected light, and a thermal filter device being arranged between the lamp and the condensing device.

### TECHNICAL FIELD

The present invention relates to a lighting device that includes at least two optical systems, each being aligned along a separate optical axis, and a light source arranged along said optical axes. The invention also relates to the use of such a lighting device for lighting in a medical instrument.

### BACKGROUND ART

Presently, lamps in for instance operating rooms at hospitals entail difficulties in the placing of the lamps, since the staff must not shade the area that should be illuminated by the lamp. Furthermore, the patient on the operating table himself can cast shadows, making it necessary for the surgeon to use a head lamp in order to illuminate the area of interest. The use of such a head lamp can inflict discomfort and heat to the surgeon's head as well as heat to the area of interest.

Lamps for operating rooms are typically 1 meter in diameter and often 2-5 operating lamps placed in an area of 3 by 3 meters are in use during surgery. There are limitations regarding the placement of these lamps, since they of course have to be placed so that the area of interest is illuminated. Due to the size of the lamps, there are additional limitations with respect to the placement of other necessary apparatuses or instruments that are needed during the surgery, which means that some instruments have to be placed behind or at a distance to the side of the surgeon.

Additionally, the generation of heat from the lamp can cause the sterile areas to be heated, which is an unwanted effect. Furthermore, the lamps can be difficult to clean which means that the cooling ventilation from the lamp can carry germs or the like to the sterile areas.

Finally, it is desirable that the colour temperature of the light is “comfortable” for the eye. Although the human visible system is incredibly adept in correcting for changes in the colour temperature, i.e. many different kinds of light seem “white” to us, it is desirable that the colour temperature of the light corresponds to the colour temperature of daylight (i.e. 5000-6000 K), since the eye will “relax” better at this colour composition. In some circumstances it can be desirable to change the colour composition, contrast or polarisation of the light by use of optical filters. However, this requires that the desired colours are present in the light sent to the filter. Since daylight contains a spectrum of continuous wavelengths from infrared (IR) through visible light to ultraviolet (UV), this will be ensured.

U.S. Pat. No. 5,584,558 discloses a lighting device that comprises a light source and two optical systems, which are orthogonally arranged. Both optical systems have a reflector consisting of a concave mirror on one side of the light source and a lens arrangement on the other side. The lens arrangements focuses light into two light pipes that emit the light, making it possible to illuminate an object from different angles at the same time. Furthermore, the light output is doubled compared to a system using only one light pipe. The preferred light sources are UV lamps, such as mercury and xenon lamps. The reflectors are dichroic mirrors that reflect UV wavelengths but are transparent to IR wavelengths, by means of which heat can be removed from the lamp. The lighting device is intended as a UV source, for instance for curing glue. For that reason electronic shutters are placed at the input ends of the light pipe, thereby making it possible to control the exposure time.

U.S. Pat. No. 6,139,175 discloses a light source device for endoscopes. It discloses an embodiment in which a light source is placed in two orthogonally arranged optical systems. Both optical systems include a condenser lens unit for collecting light beams from the light source and a light guide for receiving the light beams collected through the condenser lens unit into its entrance end to transmit them to its exit end face. A reflecting mirror is located on the opposite side of the condenser lens unit with respect to the light source. The condenser lens unit consists of a front lens and a back lens, in between which an infrared removing filter is placed.

U.S. Pat. No. 4,935,660 discloses a metal halide discharge lamp, where the colour temperature can be controlled by controlling the operation temperature of the lamp. This is obtained by fitting the discharge lamp into a transparent tubular element consisting of hard glass or quartz glass. The tubular element is coated with indium-tin-oxide or another heat reflecting material. Thereby, it is by varying the thickness of the coating possible to control the operation temperature of the lamp. In an example the colour temperature of the lamp has been changed from 4000 K to 3500 K. At the same time an increased light output measured in lumens per watt is achieved.

U.S. Pat. No. 6,963,951 discloses a metal halide discharge lamp having a heat reflective coating to increase lamp efficiency.

U.S. Pat. No. 5,003,214 discloses a metal halide discharge lamp. The lamp comprises an arc tube and a pair of electrodes, and contains a fill including an inert starting gas, mercury, and metal halides. The entire outer surface of the arc tube is coated with a heat reflective material to improve lamp efficiency.

U.S. Pat. No. 3,588,488 discloses a surgical lighting fixture. The lighting fixture uses a light source having a colour temperature of 3000 K. By using an internal cylindrical filter and a dichroic mirror surrounding the internal filter, the colour temperature is raised to 6000 K. The dichroic mirror additionally transmits IR and thermal waves in the opposite direction of the reflected light, thereby preventing that heat is sent to the patient and the doctors below.

There is thus still a need for a lighting device providing a colour temperature that corresponds to daylight and that makes it possible to illuminate an area of interest from different angles at the same time.

### DISCLOSURE OF INVENTION

The purpose of the present invention is to provide a lighting device with an adjustable colour temperature and that makes it possible to illuminate an area of interest from different angles at the same time.

This is according to the invention obtained by letting the optical systems include a reflector arranged on a first side of the light source along the optical axis, said reflector being adapted to reflect substantially all incoming light and having a curvature radius substantially equal to the distance to the light source, a condensing device arranged on a second opposite side of the lamp along the optical axis, said condensing device being adapted to receive directly incoming light from the light source and reflected light from the reflector and focusing said directly incoming and said reflected light, a light guide having a first end and a second end, said first end being arranged along the optical axis and adapted to collect and transmit substantially all of the light passing through the condensing device, said second end emitting said collected light, and a thermal filter device being arranged between the lamp and the condensing device.

The combination of the reflectors, the condensing device and the heat filters arranged between the lamp and the condensing device make it possible to adjust the colour temperature of the light sent to the area of interest and said second ends of the light guides can be placed so that the area of interest can be illuminated from different angles at the same time.

In a preferred embodiment of the lighting device, the lighting device has two optical systems only, said optical systems having a first and a second axis, respectively, said first and said second axis being substantially orthogonal. Thereby the maximal output for a single light guide is achieved.

In another preferred embodiment, the light source is a halogen lamp and preferably a metal halide discharge lamp. In yet another embodiment, the light guide is a multimode optical fibre or and optical fibre bundle. This means that the lighting device can be put together with off-the-shelf products.

In an embodiment of the invention, the optical fibre is side emitting. This means that the fibre can be used for “cold” emission of light along the length of the fibre. This can for instance be used in refrigerators or for illumination in other places where heat is un-wanted.

In a preferred embodiment of the lighting device, the thermal filter is a dichroic mirror being adapted to reflect thermal radiation and transmit visible light. This enables a simple and cheap way to implement the heat filter, while the heat filter at the same time ensures that the operation temperature is sufficient to achieve improved lamp efficiency.

In another preferred embodiment, the light guide is being arranged inside an arm, said arm being flexible and fixable in a selected position. This means that said second ends of the light guide easily can be placed and fixed so that the area of interest is illuminated.

In yet another embodiment, the curvature radius of the reflector is adjustable. This makes it possible to adjust the amount of light that is coupled into the light guide and thereby to adjust the colour temperature of the light emitted from said second end of the light guide.

A preferred embodiment of the lighting device includes a cooling device being adapted to adjust the temperature around the light source. This enables simple means to adjust the operating temperature of the lamp and thereby also the colour temperature.

In another embodiment, the lamp is replaceable arranged, thereby making it possible to replace the lamp without removing any of the other optical components in the lighting device.

In a preferred embodiment of the lighting device, the optical system additionally includes an optical filter being adapted to change the colour composition and/or contrast and/or polarisation of the transmitted light. This optical filter is preferably arranged at the second end of the light guide. This means that the white light emitted from the light source easily can be adjusted to suit special lighting needs.

In yet another preferred embodiment of the lighting device, the optical system further includes a beam splitting device, making it possible to couple light into an additional light guide. This means that the area of interest can be illuminated from more sides at a time or several areas of interest can be illuminated at the same time.

In a preferred embodiment of the lighting device, the light source is position shifted from said optical axis. Hereby, it is ensured that the light source does not shade the light that is reflected from the reflector.

The invention also relates to the use of the above lighting device for lighting in a medical instrument. This can for instance be achieved by building the light guide or optical fibre into the medical instrument. This could for instance be of use in gynaecological instruments, rib spreaders or a dentist's drill.

### BRIEF DESCRIPTION OF THE DRAWING(S)

The invention is explained in detail below with reference to the drawing(s), in which

FIG. 1 shows a lighting device according to the invention having two light emitting arms,

FIG. 2 shows a schematic view of a lighting device according to the invention having two optical systems,

FIG. 3 shows a schematic view of a lighting device according to the invention having three optical systems, and

FIG. 4 shows a schematic view of a lighting device according to the systems having a beam splitting device and an additional light guide.

### BEST MODE(S) FOR CARRYING OUT THE INVENTION

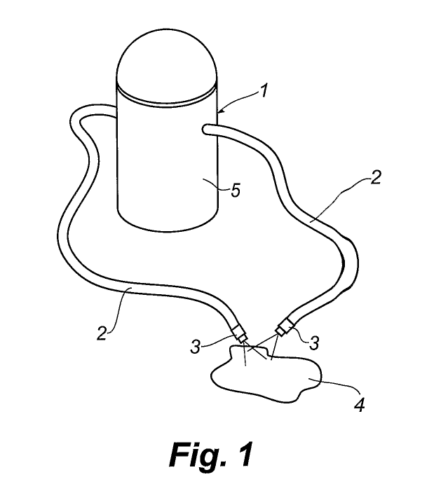

FIG. 1 is an illustration of a lighting device 1. The lighting device 1 has a housing 5 and two arms 2, which both have a light emitting end 3. The two arms 2 are flexible and fixable, thereby making it possible to place the light emitting end 3, so that the area of interest or an object 4 is illuminated from different angles. It is of course possible to place the two light emitting ends 3, so that two different areas are illuminated. This type of lamp makes it possible to place the housing 5 far from the area of interest and only draw the arms 2 to the area of interest, thereby making sure that the housing is not an obstacle to the user. The lighting device 1 could also be made as a portable device. This could for instance be interesting for a veterinary working in the field or for organisations like Medecins Sans Frontières, where lighting and/or energy consumption sometimes can be a problem.

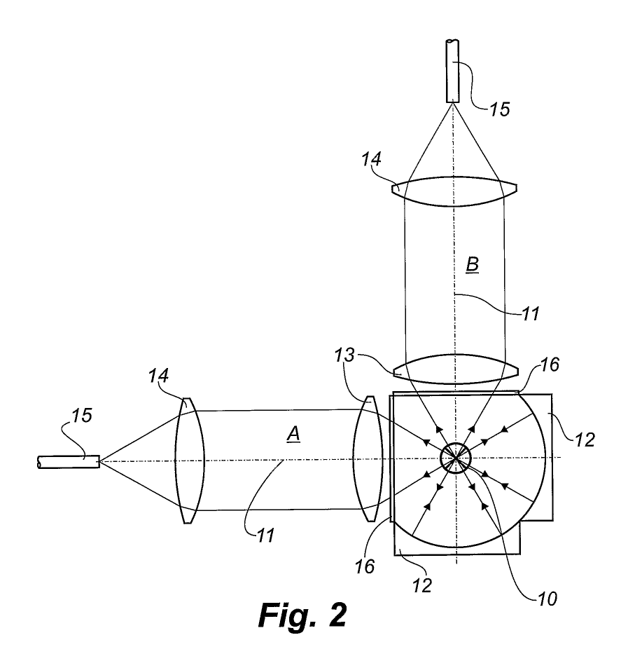

FIG. 2 shows a schematic view of the lighting device 1. The lighting device comprises a metal halide discharge lamp 10 (preferably from General Electric (GE)) and two optical systems A and B. The optical axes 11 of the two optical systems are orthogonal, and the discharge lamp 10 is placed at the cross point of the two axes 11. Each optical system comprises a reflector 12 arranged on one side of the lamp 10. The reflector reflects substantially all incoming light and has a curvature radius substantially equal to the distance to the lamp 10. This means that all reflected light is sent back through the centre of the lamp 10.

The reflector can have an elliptical shape in order to match the emission pattern of the light source.

A condensing device consisting of two condensing lenses 13, 14 is arranged on the other side of the lamp 10. The first condensing lens preferably has a focal length equal to the distance to the lamp 10, so that all light received by the lens 13 is collimated. The collimated light is sent to the second lens 14, which focuses the collimated light. The focused light is coupled into a first end of an optical multimode fibre 15 or a bundle of optical fibres. The second end of the optical fibre 15 can be placed so that the area of interest is illuminated.

The two lenses 13 and 14 are preferably identical so that the lens system forms a clean imaging system, which images the filament of the lamp 10 with a magnification of one. The lenses 13, 14 of course have to be matched with the numerical aperture of the optical fibre 15. That is, the numerical apertures of the lenses 13, 14 and the optical fibre 15 have to be as large as possible in order to couple as much light as possible into the fibre 15. Preferably the two lenses are achromats, thereby reducing chromatic aberrations in the optical system.

The optical fibre 15 is preferably lossless, which means that all the light coupled into the first end of the fibre 15 is emitted from the second end. However, it is also possible to use a side emitting fibre. The side emission can be achieved by winding up the fibre to a sufficiently small spool radius in a way known per se for the fibre to couple light out through the side. However, it could also be achieved by using a fibre having a corrugated surface. Side emitting fibres could for instance be of interest for the illumination of refrigerators or refrigerated merchandiser systems. In such systems, it is important that the products in the refrigerator are illuminated by a white light source in order for the products to display their natural colour to the customer, which can be essential for the recognition of the product. At the same time, it is desirable that the light source does not emit heat, so that the refrigerated goods are not heated. The side emitting fibre 15 would in the present system emit white light and no heat.

A thermal filter 16 is placed between the discharge lamp 10 and the lens arrangement 13, 14. The thermal filter is preferably a plane dichroic mirror 16, which reflects thermal radiation and IR wavelengths, and which is transparent to visible light. However, the thermal filter can also be implemented by use of a concave dichroic mirror having a curvature radius being matched with the distance to the discharge lamp 10. In this way, all the thermal radiation reflected by the mirror would be sent back into the discharge lamp 10, thereby increasing the operation temperature of the lamp 10 more efficiently. The thermal filter 16 can also be achieved by coating the first lens 13 with a heat reflecting coating.

The function of the thermal filter 16 is threefold. First of all, the thermal filter 16 protects the lens arrangement 13, 14 and the fibre 16, making it possible to use cheaper lenses and fibres and thereby reducing the overall cost of the system. Secondly, the thermal filter 16 ensures that the operating temperature of the lamp 10 is increased; thereby increasing the efficiency of the lamp 10. Finally, the filter ensures that no heat is sent to the area, which is to be illuminated.

The lamp 10 is preferably arranged in a holder (not shown) that makes it possible to replace the lamp 10 without having to change any of the other optical components in the system.

Preferably the lighting device has a cooling device (not shown), such as a fan or similar. The cooling device will make it possible to control the operation temperature of the lamp and thereby to control the colour temperature or white balance of the lamp 10. The fan could be directed out of the plane shown in FIG. 2. In a hospital, the lighting device 1 could be connected to existing air condition systems.

The colour temperature of the light emitted from the fibres 15 can also be controlled by changing the amount of light that is coupled into the fibres 15. This can be achieved by letting the curvature radius of the reflectors 12 be variable, for instance by installing adjustable clamps across the reflectors, said clamps being adapted to applying a pressure on the reflectors and thereby distorting the reflections to a small degree.

In some cases it can be desirable to change the properties of the light, for instance by adjusting the colour composition, contrast or polarity. This can be achieved by installing an optical filter at the second end of the fibres 15. This can for instance reduce reflections from body tissue, which can bother the surgeon, or make different types of tissue more distinguishable. The optical filter can of course also be placed in any other practical place in the optical system. Under some circumstance, for instance at eye examinations, it can also be necessary to change the size of the emitted beam. This can be achieved by installing an iris diaphragm at the second end of the fibres 15.

The setup shown in FIG. 2 makes it possible to couple more than 80 percent of the emitted light from the lamp 10 into the optical fibres 15. Tests performed with different types of metal halide discharge lamp has also shown that it is possible to change the light output to a better colour temperature as shown in the table below for lamps from GE and Philips, respectively. At the same time the efficiencies of the lamps have been increased. All the lamps have a normal colour temperature around 4000 K.

| Brand | Measured colour temperature [K] |
|---|---|
| GE10cm01 | 5168 |
| GE10cmUL01 | 5266 |
| GE20cm01 | 5187 |
| GE20cmUL01 | 5246 |
| GE30cm01 | 5253 |
| GE30cmUL01 | 5311 |
| GE40cm01 | 5290 |
| Ph10cm01 | 4953 |
| Ph10cmUL01 | 4640 |
| Ph20cm01 | 4928 |
| Ph20cmUL01 | 4665 |
| Ph30cm01 | 4743 |
| Ph30cmUL01 | 4761 |
| Ph40cm01 | 4941 |

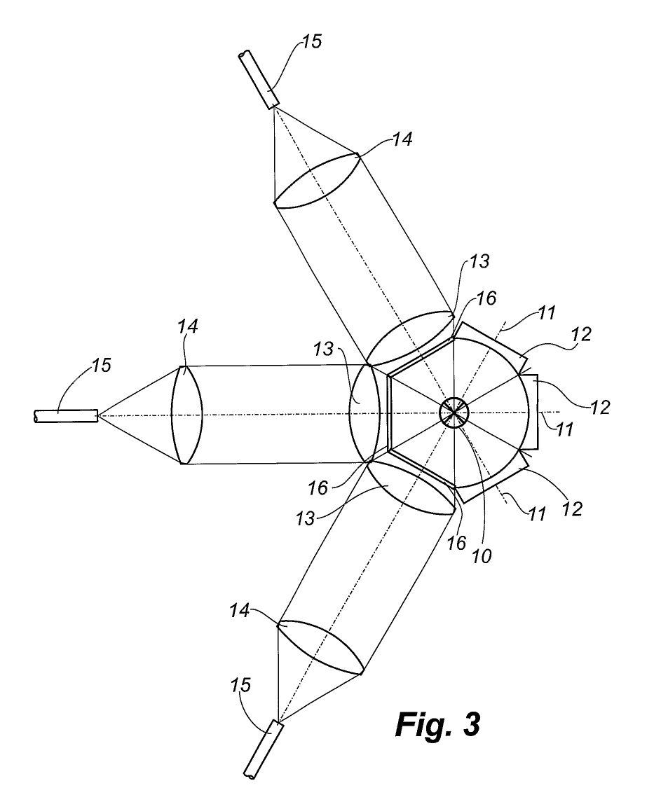

Sometimes, it will be necessary to illuminate more than two objects or from more than two angles. This can be achieved by a single lighting device with more than two optical systems and thereby more than two light emitting fibres 15. FIG. 3 shows a lighting device having three optical systems. Each optical system have an optical axis, which are shifted 60 degrees compared to each other. This means that the condensing systems each collect approximately one third of the light emitted from the lamp 10. The reflectors 11 are illustrated as three separate reflectors but might as well have been a single reflector. This setup makes it possible to couple virtually all emitted light from the lamp 10 into the fibres 15. Of course it is also possible to construct systems that have four optical systems or more.

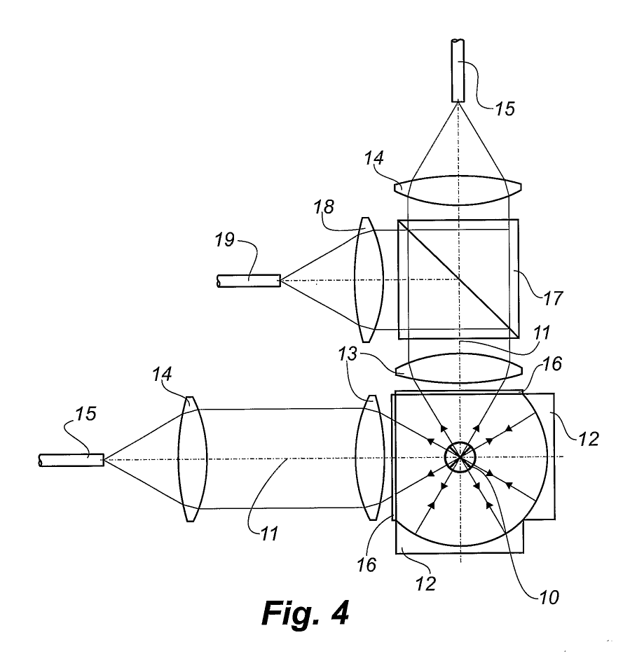

Another method for increasing the number of light emitting fibres in the system is shown in FIG. 4. In this setup, a cube beam splitter 17 known per se is placed between the two condensing lenses 13, 14 in one of the optical systems. This beam splitter will preferably split the light into two light beams of equal strength. The light split from the incoming beam is sent to a third condensing lens 18, which focuses the light and couples it into a third optical fibre 19.

Yet another method for increasing the number of light emitting fibres 15 or arms 2 in the system arises naturally when using fibre bundles for collecting the light from the lamp 10, since the individual fibres in the fibre bundle can be used for illumination separately.

One should of course be aware that increasing the number of optical systems in the lighting device 1 decreases the amount of light emitted from the individual fibres 15 and can also influence the colour temperature. Therefore it can be more desirable to use several lighting devices 1 instead of increasing the number of optical systems.

The light source 10 can be position shifted from the optical axis 11, so that the light source itself does not shade for the light reflected from the reflector 12. Typically the light source 10 will be position shifted of approximately half the filament width of the lamp. In the embodiment depicted in FIG. 2, this means that the light source must be displaced diagonally in order to be position shifted from both optical axes 11.

The above description of the invention reveals that it is obvious that it can be varied in many ways. Such variations are not to be considered a deviation from the scope of the invention, and all modifications which are obvious to persons skilled in the art are also to be considered comprised by the scope of the succeeding claims.

1-13. (canceled)

14. A lighting device including:
at least two optical systems, each being aligned along a separate optical axis (11) and
a halogen discharge lamp (10), preferably a metal halide discharge lamp, arranged along said optical axes (11),
wherein each of the optical systems include
a reflector (12) arranged on a first side of the light source (10) along the optical axis (11), said reflector (12) being adapted to reflect substantially all incoming light and having a curvature radius substantially equal to the distance to the light source (10),
a condensing device (13, 14) arranged on a second opposite side of the lamp (10) along the optical axis (11), said condensing device (13, 14) being adapted to receive directly incoming light from the light source (10) and reflected light from the reflector (12) and focusing said directly incoming and said reflected light,
a light guide (15) having a first end and a second end, said first end being arranged along the optical axis (11) and adapted to collect and transmit substantially all of the light passing through the condensing device (13, 14), said second end emitting said collected light, and
a thermal filter (16) device being arranged between the lamp (10) and the condensing device (13, 14), said thermal filter (16) device being adapted to reflect thermal radiation and transmit visible light.

15. A lighting device according to claim 14 characterised by having two optical systems only, said optical systems having a first and a second axis, respectively, said first and said second axis being substantially orthogonal.

16. A lighting device according to claim 14 characterised in that said light emitting lamp (10) being a halogen lamp, preferably a metal halide discharge lamp.

17. A lighting device according to claim 14 characterised in that the light guide (15) is a multimode optical fibre or an optical fibre bundle.

18. A lighting device according to claim 14 characterised in that the light guide (15) is side emitting.

19. A lighting device according to claim 14 characterised in that said thermal filter (16) is a dichroic mirror being adapted to reflect thermal radiation and transmit visible light.

20. A lighting device according to claim 14 characterised in that the light guide (15) is being arranged inside an arm (2), said arm (2) being flexible and fixable in a selected position.

21. A lighting device according to claim 14 characterised in that the curvature radius of the reflector (12) is adjustable.

22. A lighting device according to claim 14 characterised by further including a cooling device being adapted to adjust the temperature around the light source (10).

23. A lighting device according to claim 14 characterised in that the optical system additionally includes an optical filter being adapted to change the colour composition and/or contrast and/or polarisation of the transmitted light, said optical preferably being arranged at the second end of the light guide (15).

24. A lighting device according to claim 14 characterised in that the optical system further includes a beam splitting device (17), making it possible to couple light into an additional light guide (19).

25. A lighting device according to claim 14, characterised in that the light source (10) is position shifted from said optical axes (11).

26. Use of a lighting device according to claim 14 for lighting in a medical instrument.

27. A lighting device according to claim 15 characterised in that said light emitting lamp (10) being a halogen lamp, preferably a metal halide discharge lamp.
